(19) United States
(12) Patent Application Publication
(10) Pub. No.: US 2024/0386506 A1
(43) Pub. Date: Nov. 21, 2024

(54) METHOD, ELECTRONIC APPARATUS, AND STORAGE MEDIUM FOR ANALYZING USER RELATIONSHIPS IN A SOCIAL NETWORK

(71) Applicant: Beijing Hydrophis Network Technology Co., Ltd., Beijing (CN)

(72) Inventor: Feng Hong, Beijing (CN)

(21) Appl. No.: 18/599,639

(22) Filed: Mar. 8, 2024

(30) Foreign Application Priority Data
May 17, 2023 (CN) 202310558117.0

(51) Int. Cl. G06Q 50/00

(52) U.S. Cl. CPC G06Q 50/01

(57) ABSTRACT

The present disclosure relates to user relationship analysis technology, and discloses a method, electronic apparatus, and storage medium for analyzing user relationships in a social network. The method includes: acquiring original data of training users, and performing training user information division on the original data to obtain target information; defining relationships between the training users according to the target information to obtain a user relationship network; performing node feature extraction on the user relationship network according to preset influencing factors to obtain feature data corresponding to the influencing factors; and constructing a user relationship analysis model based on the feature data, and performing relationship prediction on user data of a preset user to be tested using the user relationship analysis model to obtain the user relationship of the user to be tested. The present disclosure can improve the accuracy of user relationship prediction in the user relationship analysis technology.

### CROSS REFERENCE TO RELATED APPLICATIONS

The present application claims the benefit of Chinese Patent Application No. 202310558117.0 filed on May 17, 2023, the contents of which are incorporated herein by reference in their entirety.

### TECHNICAL FIELD

The present disclosure relates to the technical field of user relationship analysis, and more particularly to a method, electronic apparatus, and storage medium for analyzing user relationships analysis in a social network.

### BACKGROUND

The maturing mobile internet technology is penetrating into people's daily lives. With social software such as QQ, WeChat, and Weibo, more and more people are joining the internet social network. Online social networks have become an important tool for people's daily communication, entertainment, and communication. User relationships in the network is the foundation of online social networks, which greatly affects the formation and development of online social networks. Therefore, it is particularly important to analyze the factors that affect the user relationships. User relationship analysis can help people better understand evolution patterns and development directions of the network, and related research can be widely applied to various fields, such as product recommendation in e-commerce, resulting in huge economic and social benefits.

At present, user relationship analysis in social networks mainly focus on user relationship strength and user relationship prediction. The user relationship prediction mainly focuses on link prediction, and usually analyzes the user relationships using a similarity index, such as common neighbors, Jaccard coefficient, Adamic/Adaic, and Katz. However, in these methods, only network topology information is considered, while other information that can be used to improve the accuracy of relationship prediction is ignored, resulting in low prediction accuracy. In summary, existing user relationship analysis technologies have the problem of low accuracy in relationship prediction.

### SUMMARY

The present disclosure provides a method, electronic apparatus, and storage medium for analyzing user relationships in a social network, aiming at solving the problem of low accuracy in relationship prediction in user relationship analysis technology.

The method for analyzing user relationships in a social network including:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors; and
constructing a user relationship analysis model based on the feature data, and performing relationship prediction on user data of a preset user to be tested using the user relationship analysis model to obtain a user relationship of the user to be tested.

In an embodiment, the performing training user information division on the original data to obtain target information includes:
transforming the original data to obtain standard data;
calculating a neighborhood distance of the standard data to obtain a neighborhood mean value;
obtaining a weight coefficient of the standard data, calculating matrix elements of the standard data according to the neighborhood mean value and the weight coefficient using the following formula, and generating a probability transition matrix according to the matrix elements:

$$p = z \frac{{Mean}_{i}}{d ( {x}_{i} , {{x}_{i}}^{k} ) , {p}_{i} > 0}$$

wherein, p represents the probability transition matrix; Meanᵢ represents the neighborhood mean value of an i-th piece of standard data; z represents the weight coefficient of the standard data; d(xᵢ, xᵢ^{k}) represents a distance between the i-th piece of standard data and a neighborhood xᵢ^{k} of the i-th piece of standard data xᵢ;
describing a similarity of the standard data based on the probability transition matrix to obtain a similarity value using the following formula:

f=Σᵢ₌₁Tp(z,xᵢ);
wherein, f represents the similarity value; T represents a preset similarity parameter; p represents the probability transition matrix; z represents the weight coefficient of the standard data; xᵢ indicates as the i-th piece of standard data; and
processing abnormal information of the standard data according to the similarity value to obtain the target information.

In an embodiment, the transforming the original data into standard data includes:
converting the original data into a database according to a preset file template to obtain a simulation output file;
generating a database object set according to the simulation output file; and
performing file parsing on the database object set to obtain the standard data.

In an embodiment, the defining relationships between the training users according to the target information to obtain a user relationship network includes:
performing relationship judgment on the training users according to the target information, and labeling the training users according to a result of the relationship judgment to obtain an initial user set;
generating an initial user relationship network of the training users according to the initial user set; and
defining relationships of the initial user relationship network to obtain a user relationship network.

In an embodiment, the performing node feature extraction on the user relationship network according to preset influencing factors to obtain feature data corresponding to the influencing factors includes:
performing information extraction on the user relationship network according to the influencing factors to obtain a feature set corresponding to the influencing factors;
establishing an influencing factor function according to the feature set;
performing feature extraction on the user relationship network using the influencing factor function to obtain the feature data corresponding to the influencing factors.

In an embodiment, the constructing a user relationship analysis model based on the feature data includes:
constructing the user relationship analysis model based on the feature data using the following formula:

$$H = \frac{S - T}{S + T}$$

wherein, H represents the user relationship analysis model; S represents the feature data of the training user; T represents a preset relationship parameter of the training user.

In an embodiment, the performing relationship prediction on user data of a preset user to be tested using the user relationship analysis model to obtain a user relationship of the user to be tested:
performing feature extraction on the user data to obtain the feature data of the user to be tested;
performing a relationship calculation on the feature data of the user to be tested using the user relationship analysis model to obtain a relationship value; and
determining the user relationship of the user to be tested according to the relationship value.

The present disclosure further provides a device for analyzing user relationships in a social network, including:
a training user information division module, configured to acquire original data of training users and perform training user information division on the original data to obtain target information;
a user relationship network generation module, configured to define relationships between the training users according to the target information to obtain a user relationship network;
a node feature extraction module, configured to perform node feature extraction on the user relationship network according to preset influencing factors to obtain feature data corresponding to the influencing factors;
a user relationship prediction module, configured to construct a user relationship analysis model based on the feature data, and perform relationship prediction on user data of a preset user to be tested using the user relationship analysis model to obtain a user relationship of the user to be tested.

The present disclosure further provides an electronic apparatus, including at least one processor and a memory communicatively connected to the at least one processor, wherein the memory stores a computer program executable on the at least one processor, and the computer program is executed by the at least one processor to enable the at least one processor to perform the above method for analyzing user relationships in a social network.

The present disclosure further provides a computer-readable storage medium storing a computer program, which, when being executed by a processor, implements the above method for analyzing user relationships in a social network.

The method for analyzing user relationships in a social network provided in the present disclosure defines the relationship of the training users based on the target information to obtain the user relationship network, which can analyze the relationship of the training users and mine the influencing factors of the relationship. Based on the influencing factors, the node feature extraction is performed on the user relationship network to obtain the feature data corresponding to the influencing factors. The feature analysis can be performed from multiple perspectives, and feature information under each perspective can be quantified to improve the accuracy of relationship prediction. Based on the feature data, the user relationship analysis model is constructed to predict the relationship of the user to be tested, enhance the correlation between user data, and effectively improve the effectiveness of user relationship prediction. Therefore, the method for analyzing user relationships provided in the present disclosure can solve the problem of low accuracy in relationship prediction in user relationship analysis technology.

### BRIEF DESCRIPTION OF THE DRAWINGS

In order to explain the technical solutions in the embodiments of the present disclosure or the prior art more clearly, the drawings used by the description of the embodiments or the prior art will be briefly introduced below. Obviously, the drawings in the following description may be merely some embodiments of the present disclosure. For those of ordinary skilled in the art, other drawings may be obtained according to the structures shown in the drawings without creative effort.

FIG. 1 is a flowchart of a method for analyzing user relationships in a social network according to an embodiment of the present disclosure;

FIG. 2 is a flowchart of a step of performing training user information division on original data to obtain target information according to an embodiment of the present disclosure;

FIG. 3 is a flowchart of a step of performing node feature extraction on the user relationship network according to preset influencing factors and obtaining feature data corresponding to the influencing factors according to an embodiment of the present disclosure;

FIG. 4 is a functional block diagram of a device for analyzing user relationships in a social network according to an embodiment of the present disclosure;

FIG. 5 is a structural diagram of an electronic apparatus for implementing the method for analyzing user relationships in a social network according to an embodiment of the present disclosure.

The realization of the purpose, functional characteristics and advantages of the present disclosure will be further explained with reference to the accompanying drawings in conjunction with the embodiments.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments may be only a part of the embodiments of the present disclosure, but not all of the embodiments. Based on the embodiments of the present disclosure, all other embodiments obtained by those of ordinary skilled in the art without creative effort shall fall within the protection scope of the present disclosure.

It should be understood that the specific embodiments described here are only used to explain the invention and are not used to limit the invention.

The embodiments of the present disclosure provide a method for analyzing user relationships in a social network. The execution body of the method for analyzing user relationships in a social network includes but is not limited to at least one of electronic apparatus such as server and terminal that can be configured to execute the method provided by the embodiments of the present application. In other words, the method for analyzing user relationships in a social network can be executed by software or hardware installed on terminal devices or server devices, and the software can be a blockchain platform. The server includes but is not limited to a single server, a server cluster, a cloud server, or a cloud server cluster. The server can be an independent server, or a cloud server that provides basic cloud computing services such as cloud services, cloud databases, cloud computing, cloud functions, cloud storage, network services, cloud communication, middleware services, domain name services, security services, content delivery network (CDNs), and big data and artificial intelligence platforms.

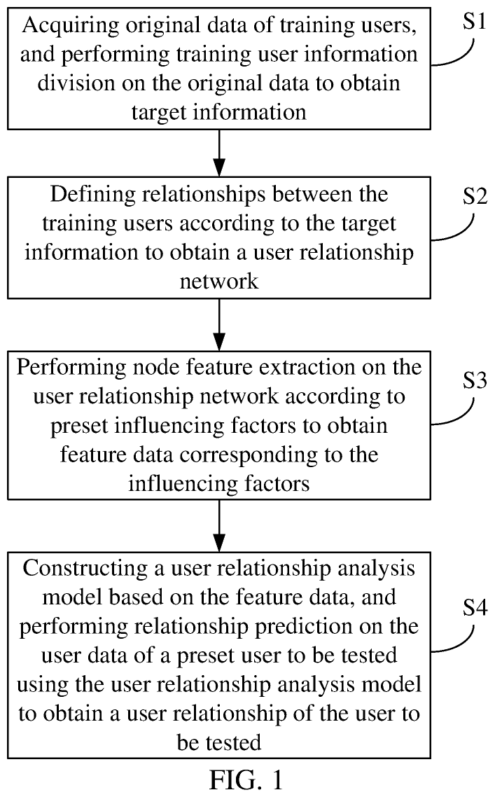

Referring to FIG. 1, which is a flow diagram of the method for analyzing user relationships in a social network according to an embodiment of the present disclosure, the method for analyzing user relationships in a social network includes steps as follows.

S1, acquiring original data of training users, and performing training user information division on the original data to obtain target information.

In the embodiment of the present disclosure, the original data of the training users can be obtained from social software of the training users such as Microblog and WeChat Moments, including user ID, user avatar, gender, personal profile, etc. The original data of the training users also can be obtained through network crawler software or an open API (application programming interface) platform of the social software. The API platform is an open platform in the software industry that can encapsulate website services of the social software such as WeChat and Microblog into a series of data interfaces that are easily recognized by computers, so that the original data of the training users can be obtained through these data interfaces. The original data includes structured data and unstructured data, wherein, unstructured data refers to non-numeric data such as text and electronic documents.

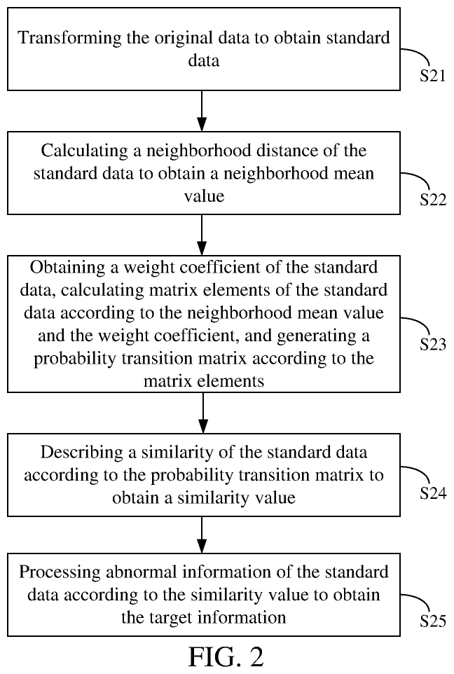

Referring to FIG. 2, in the embodiment of the present disclosure, the performing training user information division on the original data to obtain target information includes:

S21, transforming the original data to obtain standard data;

S22, calculating a neighborhood distance of the standard data to obtain a neighborhood mean value;

S23, obtaining a weight coefficient of the standard data, calculating matrix elements of the standard data according to the neighborhood mean value and the weight coefficient, and generating a probability transition matrix according to the matrix elements;

S24, describing a similarity of the standard data according to the probability transition matrix to obtain a similarity value; and

S25, processing abnormal information of the standard data according to the similarity value to obtain the target information.

In the embodiment of the present disclosure, the unstructured data in the original data is transformed into the structured data; and the neighborhood distance refers to the distance d (xᵢ, xᵢ^{k}) between the standard data xᵢ (i=1, 2, 3, . . . , n; wherein n is a natural number) and the data neighborhood xᵢ^{k} of the standard data xⱼ. The Euclidean distance calculation formula can be used to calculate dimensions of the standard data in a two-dimensional space. The abnormal information is processed based on the similarity value to screen the standard data, and the standard data with a similarity value less than 0.7 can be removed to obtain the target information.

In the embodiment of the present disclosure, the transforming the original data to obtain standard data includes:
converting the original data into a database according to a preset file template to obtain a simulation output file;
generating a database object set according to the simulation output file; and
performing file parsing on the database object set to obtain the standard data.

In the embodiment of the present disclosure, the file template is selected according to the storage location of the original data, and the database can be SQL database, document database, etc. The format category of the simulation output file corresponds to the database, and each database has a separate simulation output file format. The format category of the simulation output file includes horizontal, vertical, and linked list, etc. The database object set can include tables, columns, data types, etc. When the file parsing is performed, SAX (Simple API for XML, file drive model) software package can be used to scan and parse the database object set to obtain the standard data, which can quickly and easily process the database object set and improve the efficiency of the file parsing.

In the embodiment of the present disclosure, the matrix elements of the standard data are calculated according to the neighborhood mean value and the weight coefficient using the following formula, and the probability transition matrix is generated according to the matrix elements:

$$p = z \frac{{Mean}_{i}}{d ( {x}_{i} , {{x}_{i}}^{k} ) , {p}_{i} > 0} ;$$

wherein, p represents the probability transition matrix; Mean; represents a neighborhood mean value of an i-th piece of standard data; z represents the weight coefficient of the standard data; d(xᵢ,xᵢ^{k}) represents a distance between as the i-th piece of standard data and the neighborhood xᵢ^{k} of the i-th piece of standard data xᵢ.

In the embodiment of the present disclosure, the similarity value is obtained by using the following formula to describe the similarity of the standard data according to the probability transition matrix:

f=Σᵢ₌₁Tp(z,xᵢ);
wherein, f represents the similar value; T represents a preset similarity parameter; p represents the probability transition matrix; z represents the weight coefficient of the standard data; xᵢ indicates as the i-th piece of standard data.

S2, defining relationships between the training users according to the target information to obtain a user relationship network.

In the embodiment of the present disclosure, the defining relationships between the training users according to the target information to obtain a user relationship network includes:
performing relationship judgment on the training users according to the target information, and labeling the training users according to a result of the relationship judgment to obtain an initial user set;
generating an initial user relationship network of the training users according to the initial user set; and
defining relationships of the initial user relationship network to obtain a user relationship network.

In the embodiment of the present disclosure, the relationship judgment of the training users is performed to determine whether there is a mutual attention relationship between the training users. For example, when the training users are Weibo users, if Weibo accounts of the training users are mutually following, it is determined that there is a mutual attention relationship between the training users; when the training users are WeChat users, if WeChat accounts of the training users are mutual friends, it is determined that there is a mutual attention relationship between the training users; for any training user vⱼ and another training users vₗ, if there is a mutual attention relationship between the two training users, it is determined that the training user vⱼ has a user relationship with the training user vₗ. If there is no mutual attention relationships between the two training users, it is determined that the training user vⱼ does not have a user relationship with the training user v₁. The training user is labeled based on the result of the relationship judgment, for example, the user relationship between the training user vⱼ and the training user vₗ is labeled as R_{j,l}=1 when there is a user relationship between the training user vⱼ and the training user vₗ, and the user relationship between the training user vⱼ and the training user vₗ is labeled as R_{j,l}=0 when there is no user relationships between the training user vⱼ and the training user vₗ.

In the embodiment of the present disclosure, the initial user relationship network is formed by edges and nodes, wherein the edges represent the user relationships and the nodes represent the training users. The initial user relationship network can be represents as G=(V, E), wherein, V represents the initial user set, and the number of the training users in the initial user set is equal to the number of the training users, that is, |V|=N (wherein N represents the number of the training users); E represents a user relationship edge in the initial user relationship network, that is, whether there is a relationship between the training users.

In the embodiment of the present disclosure, the user relationship network can be represents as G′=G(V′,E′), wherein G′ represents a full user relationship network, that is, the user relationship network; V′ represents the total number of the training users in the user relationship network, E′ represents the user relationship in the user relationship network; and the initial user relationship network is included in the user relationship network, that is, G⊂G′.

S3, performing node feature extraction on the user relationship network according to preset influencing factors to obtain feature data corresponding to the influencing factors.

In the embodiment of the present disclosure, there are three types of the influencing factors: personal interest, friend relationship, and community drive. The personal interest can reflect the similarity between two nodes in the user relationship network; the greater the similarity between two nodes in the user relationship network, the greater the possibility of a link existed between the two nodes. The friend relationship can reflect the probability of a link existed between two users; when two training users have common friends, the probability of a link existed between the two training users is correspondingly higher. Therefore, common followings and common followers between the training users can be used as features for establishing an impression link; the community drive also affects the probability of a link existed between the training users. Since the training users belonging to a community are more closely connected, a link may be more easily generated between two training users belonging to a community.

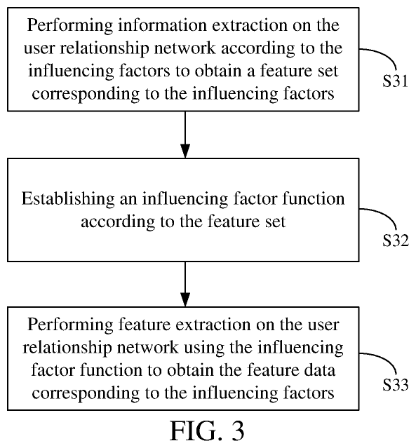

Referring to FIG. 3, in the embodiment of the present disclosure, the performing node feature extraction on the user relationship network according to preset influencing factors to obtain feature data corresponding to the influencing factors includes:

S31, performing information extraction on the user relationship network according to the influencing factors to obtain a feature set corresponding to the influencing factors;

S32, establishing an influencing factor function according to the feature set; and

S33, performing feature extraction on the user relationship network using the influencing factor function to obtain the feature data corresponding to the influencing factors.

In the embodiment of the present disclosure, the information extraction is performed to extract personal interest information, friend relationship information, and community information of the training user according to the influencing factors. The feature set of personal interests is defined at first. If there is a common interest between the training user vⱼ and the training user vₗ, an interest relationship set of a node vⱼ and a node vₗ is generated as A_{j,l}=1 in the user relationship network; on the contrary, the interest relationship set is generated as A_{j,l}=0. The common followings and common followers between two training users can be used as elements of a friend relationship set. If there are common followings and common followers between the training users, a friend relationship set of the node vⱼ and the node vₗ is generated as B_{j,l}=1, otherwise, the friend relationship set is generated as A_{j,l}=0. For a community feature set, CPM (community classification algorithm) can be used to determine whether the training users belong to the same community. If the training users vⱼ and the training user vₗ belong to the same community, a community relationship set of the node vⱼ and the node vₗ is generated as C_{j,l}=1, otherwise, the community relationship set is generated as C_{j,l}=0.

In the embodiment of the present disclosure, the feature set is D=(A_{j,l}, B_{j,l}, C_{j,l}). The influencing factor function is Q(D,Y)=D(D≠0∩Y=1), wherein, Y represents a link relationship between the training users, when there is a link relationship between the training users, Y=1, otherwise Y=0. The feature extraction can adopt the principal component analysis method to map the feature set in the user relationship network to a preset dimensional space, where a dimension of the feature set is greater than a dimension of the dimensional space, and the dimension of the dimensional space is the principal component. The feature data corresponding to the influencing factors is generated based on a distribution of the feature set in the dimensional space.

S4, constructing a user relationship analysis model based on the feature data, and performing relationship prediction on the user data of a preset user to be tested using the user relationship analysis model to obtain a user relationship of the user to be tested.

In the embodiment of the present disclosure, the user relationship analysis model is constructed according to the feature data using the following formula:

$$H = \frac{S - T}{S + T} ;$$

wherein, H represents the user relationship analysis model; S represents the feature data of the training user; T represents a preset relationship parameter of the training user.

In the embodiment of the present disclosure, the performing relationship prediction on the user data of a preset user to be tested using the user relationship analysis model to obtain a user relationship of the user to be tested includes:
performing feature extraction on the user data to obtain the feature data of the user to be tested;
performing a relationship calculation on the feature data of the user to be tested using the user relationship analysis model to obtain a relationship value; and
determining the user relationship of the user to be tested according to the relationship value.

In the embodiment of the present disclosure, the user data of the user to be tested is a data set including three influencing factors: personal interests, friendships, and community drives of the user to be tested. A main component analysis is performed on the three influencing factors respectively, to obtain the feature data of the user to be tested. In the relationship calculation, the feature data of the user to be tested is substituted into the user relationship analysis model to obtain the relationship value of the user to be tested. A range of an output of the user relationship analysis model is [−1,1]. When the relationship value output by the user relationship analysis model is closer to 1, it indicates that the link between the training users is stronger, that is, the relationship distribution between the training users is close. When the relationship value of the user relationship analysis model is closer to −1, it indicates that the link between the training users is weaker, that is, the relationship distribution between the training users is random.

The method for analyzing user relationships in a social network provided in the present disclosure defines the relationship of the training users based on the target information to obtain the user relationship network, which can analyze the relationship of the training users and mine the influencing factors of the relationship. Based on the influencing factors, the node feature extraction is performed on the user relationship network to obtain the feature data corresponding to the influencing factors. The feature analysis can be performed from multiple perspectives, and feature information under each perspective can be quantified to improve the accuracy of relationship prediction. Based on the feature data, the user relationship analysis model is constructed to predict the relationship of the user to be tested, enhance the correlation between two pieces of user data, and effectively improve the effectiveness of user relationship prediction. Therefore, the method for analyzing user relationships in a social network provided in the present disclosure can solve the problem of low accuracy in relationship prediction in the user relationship analysis technology.

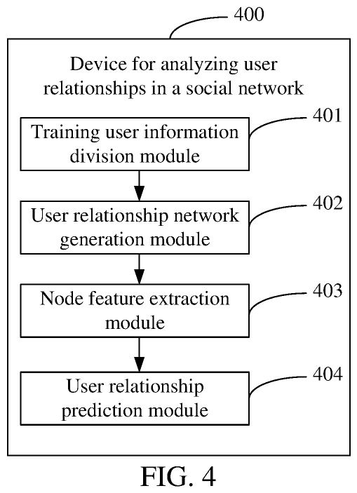

As shown in FIG. 4, which is a functional module diagram of a device for analyzing user relationships in a social network in accordance with an embodiment of the present disclosure, the device 400 for analyzing user relationships in a social network described in the present disclosure can be installed in an electronic apparatus. According to the functions implemented, the device 400 may include a training user information division module 401, an user relationship network generation module 402, a node feature extraction module 403, and an user relationship prediction module 404. The modules described in the present disclosure can also be referred to as units, which refer to a series of computer program segments that can be executed by the processor of an electronic apparatus and can complete fixed functions.

The training user information division module 401 is configured to obtain original data of training users and perform training user division information on the original data to obtain target information.

The user relationship network generation module 402 is configured to define relationships between the training users according to the target information to obtain a user relationship network.

The node feature extraction module 403 is configured to perform node feature extraction on the user relationship network according to preset influencing factors to obtain feature data corresponding to the influencing factors.

The user relationship prediction module 404 is configured to construct a user relationship analysis model based on the feature data, and perform relationship prediction on user data of a preset user to be tested using the user relationship analysis model to obtain a user relationship of the user to be tested.

In detail, the modules of the device 400 for analyzing user relationships in a social network described in the embodiment of the present disclosure, adopt the same technical means as the user relationship analysis method for social networks described in the drawings when used, and can produce the same technical effects, which will not be repeated here.

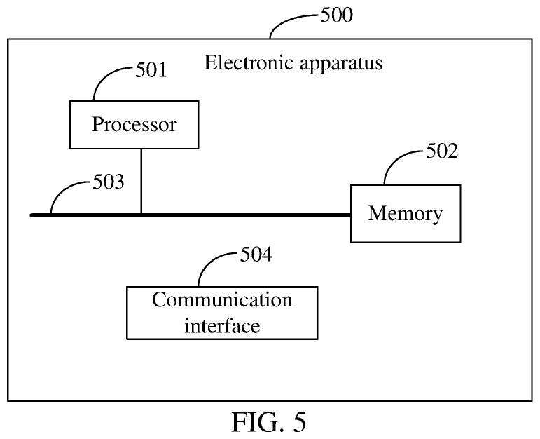

As shown in FIG. 5, which is a structural diagram of an electronic apparatus for implementing the method for analyzing user relationships in a social network in accordance with an embodiment of the present disclosure, the electronic apparatus 500 may include a processor 501, a memory 502, a communication bus 503, and a communication interface 504. The electronic apparatus may also include computer programs stored in the memory 502 and executable on the processor 501, such as a program for analyzing user relationships in a social network.

The processor 501 may be composed of integrated circuits. For example, the processor 501 may be composed of a single integrated circuit, or may be composed of multiple integrated circuits of the same function or different functions. The processor 501 may include one or more central processing units (CPU), a microprocessor, a digital processing chip, a graphics processor, or a combination of various control chips. The processor 501 is the control unit of the electronic apparatus, which connects various components of the entire electronic apparatus using various interfaces and lines, and executes various functions and processes data by running or executing programs or modules (such as the program for generating an entity information graph) stored in the memory 502, and invoking data stored in the memory 502.

The memory 502 includes at least one type of readable storage medium, which includes a flash memory, a removable hard disk, a multimedia card, a card-type storage (such as SD or DX storage), a magnetic storage, a magnetic disk, and an optical disk. In some embodiments, the memory 502 can be an internal storage unit of the electronic apparatus, such as the removable hard disk of the electronic device. In other embodiments, the memory 502 can also be an external storage device of the electronic apparatus, such as a plug-in removable hard disk, a smart media card (SMC), a secure digital (SD) card, and a flash card. The memory 502 can also include both the internal storage unit and the external storage device of the electronic apparatus. The memory 502 can be used not only to store application software and various data installed in the electronic apparatus, such as codes of the program for analyzing user relationships in a social network, but also to temporarily store data that has been output or will be output.

The communication bus 503 may be a peripheral component interconnect (PCI) bus or an extended industry standard architecture (EISA) bus. The communication bus can include an address bus, a data bus, a control bus, etc. The communication bus is configured to realize the connection and communication between the memory 502 and at least one processor 501, etc.

The communication interface 504 is used for communication between the electronic apparatus and other devices, including network interfaces and user interfaces. Optionally, the network interfaces can include wired interfaces and/or wireless interfaces (such as WI-FI interfaces and Bluetooth interfaces), which are usually used to establish communication connections between the electronic apparatus and other electronic devices. The user interface can be a display, an input unit (such as a keyboard); optionally, the user interface can also be a standard wired interface or a wireless interface. In some embodiments, the display can be a light emitting diode (LED) display, a liquid crystal display, a touch-sensitive liquid crystal display, and a organic light emitting diode (OLED) touch screen. In this disclosure, the display can also be appropriately termed as a display screen or a display unit, which is used for displaying information processed in the electronic apparatus, and displaying a visual user interface.

FIG. 5 only shows the electronic apparatus with some components. Those skilled in the art can understand that the structure shown in FIG. 5 does not constitute a limitation on the electronic apparatus, and the electronic apparatus can include fewer or more components than those shown, or a combination of some components, or have different component arrangements.

For example, although not shown, the electronic apparatus may also include a power supply (such as a battery) that supplies power to various components. In some embodiments, the power supply may be logically connected to the at least one processor 501 through a power management device, thereby enabling charging management, discharging management, and power consumption management functions through the power management device. The power supply may also include one or more DC or AC power supplies, recharging devices, power failure detection circuits, power converters or inverters, power status indicators, and any other components. The electronic apparatus may also include various sensors, Bluetooth modules, Wi-Fi modules, etc., which is not further described here.

It should be understood that the embodiments described are for illustrative purposes only and are not limited by this structure in the scope of the present disclosure.

The program for analyzing user relationships in a social network stored in the memory 502 of the electronic apparatus 500 is a combination of multiple instructions, which when executed in the processor 501 can implement:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors;
constructing a user relationship analysis model based on the feature data, and performing relationship prediction on user data of a preset user to be tested using the user relationship analysis model to obtain a user relationship of the user to be tested.

In an embodiment, the specific implementation method of the processor 501 for the above instructions can be referred to the description of the relevant steps in the corresponding embodiments of the attached drawings, which is not repeated here.

Further, if the module/unit integrated into the electronic apparatus is implemented in the form of a software functional unit and sold or used as an independent product, it can be stored in a computer-readable storage medium. The computer-readable storage medium can be volatile or non-volatile. For example, the computer-readable medium can include any entity or device capable of carrying the computer program code, recording medium, U disk, mobile hard disk, magnetic disk, optical disk, computer memory, read-only memory (ROM).

The present disclosure also provides a computer-readable storage medium storing a computer program, which, when being executed by a processor of an electronic device, can implement:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors;
constructing a user relationship analysis model based on the feature data, and performing relationship prediction on user data of a preset user to be tested using the user relationship analysis model to obtain a user relationship of the user to be tested.

In the several embodiments provided by the present disclosure, it should be understood that the disclosed apparatus, devices and methods can be implemented in other ways. For example, the device embodiments described above are only illustrative. For example, the division of modules is only a logical function division, and there may be other division methods in actual implementation.

The modules described as separate components may or may not be physically separated, and the components displayed as modules may or may not be physical units, that is, they may be located in one place or distributed across multiple network units. Some or all of the modules can be selected according to actual needs to achieve the objectives of this embodiment.

Additionally, various functional modules described in the embodiments herein may be integrated into one processing unit or may be present as a number of physically separated units, and two or more units may be integrated into one. The above integrated units may be implemented by hardware or by hardware in combination with software functional modules.

It will be appreciated that the foregoing embodiments are merely illustrative of the technical solutions of this disclosure and are not restrictive. Various modifications, changes, or equivalent substitutions can be made to the disclosure without departing from the spirit and scope of the technical solutions of the disclosure.

Therefore, from any point of view, the foregoing embodiments are to be regarded in all respects as illustrative and not restrictive, and the scope of the disclosure is defined by the appended claims rather than by the foregoing description. The present disclosure is therefore intended to embrace all changes that fall within the meanings and ranges of the equivalent elements of the claims. No reference sign shown in the accompanying drawings that are recited in a claim should be considered as a restriction on the claim involved.

The embodiments of the present disclosure can acquire and process relevant data based on artificial intelligence (AI) technology. Wherein, AI is a theory, method, technology, and application system that uses digital computers or machines controlled by digital computers to simulate, extend, and expand human intelligence, perceive the environment, acquire knowledge, and use knowledge to obtain the best results.

In addition, it is manifest that the term “comprising,” or “including,” does not exclude other elements or steps, and the singular form does not exclude the plural. A plurality of units or devices recited in the system claims may also be implemented by one unit or device through software or hardware. Terms such as “first,” “second,” (if any) are used to indicate names rather than any particular order.

Finally, it should be noted that the above embodiments are only used to illustrate the technical solutions of the present disclosure and are not limitations. Although the present disclosure has been described in detail with reference to preferred embodiments, those skilled in the art should understand that the technical solutions of the present disclosure can be modified or equivalently replaced without departing from the spirit and scope of the technical solutions of the present disclosure.

What is claimed is:

1. A method for analyzing user relationships in a social network, comprising:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors; and
constructing a user relationship analysis model based on the feature data, and performing relationship prediction on user data of a preset user to be tested using the user relationship analysis model to obtain user relationships of the user to be tested.

2. The method according to claim 1, wherein the performing training user information division on the original data to obtain target information comprises:
transforming the original data to obtain standard data;
calculating a neighborhood distance of the standard data to obtain a neighborhood mean value;
obtaining a weight coefficient of the standard data, calculating matrix elements of the standard data according to the neighborhood mean value and the weight coefficient using the following formula, and generating a probability transition matrix according to the matrix elements:
$$p = z \frac{{Mean}_{i}}{d ( {x}_{i} , {{x}_{i}}^{k} ) , {p}_{i} > 0}$$
wherein, p represents the probability transition matrix; Meanᵢ represents the neighborhood mean value of an i-th piece of standard data; z represents the weight coefficient of the standard data; d(xᵢ,xᵢ^{k}) represents a distance between the i-th piece of standard data and a neighborhood xᵢ^{k} of the i-th piece of standard data xᵢ;
describing a similarity of the standard data based on the probability transition matrix to obtain a similarity value using the following formula:
$$f = {\sum }_{i = 1} Tp ( z , {x}_{i} )$$
wherein, f represents the similarity value; T represents a preset similarity parameter; p represents the probability transition matrix; z represents the weight coefficient of the standard data; xᵢ indicates as the i-th piece of standard data; and
processing abnormal information of the standard data according to the similarity value to obtain the target information.

3. The method according to claim 2, wherein the transforming the original data into standard data comprises:
converting the original data into a database according to a preset file template to obtain a simulation output file;
generating a database object set according to the simulation output file; and
performing file parsing on the database object set to obtain the standard data.

4. The method according to claim 1, wherein the defining relationships between the training users according to the target information to obtain a user relationship network comprises:
performing relationship judgment on the training users according to the target information, and labeling the training users according to a result of the relationship judgment to obtain an initial user set;
generating an initial user relationship network of the training users according to the initial user set; and
defining relationships of the initial user relationship network to obtain a user relationship network.

5. The method according to claim 1, wherein the performing node feature extraction on the user relationship network according to preset influencing factors to obtain feature data corresponding to the influencing factors comprises:
performing information extraction on the user relationship network according to the influencing factors to obtain a feature set corresponding to the influencing factors;
establishing an influencing factor function according to the feature set;
performing feature extraction on the user relationship network using the influencing factor function to obtain the feature data corresponding to the influencing factors.

6. The method according to claim 1, wherein the constructing a user relationship analysis model based on the feature data comprises:
constructing the user relationship analysis model based on the feature data using the following formula:
$$H = \frac{S - T}{S + T} ;$$
wherein, H represents the user relationship analysis model; S represents the feature data of the training user; T represents a preset relationship parameter of the training user.

7. The method according to claim 1, wherein the performing relationship prediction on user data of a preset user to be tested using the user relationship analysis model to obtain a user relationship of the user to be tested:
performing feature extraction on the user data to obtain feature data of the user to be tested;
performing a relationship calculation on the feature data of the user to be tested using the user relationship analysis model to obtain a relationship value; and
determining the user relationship of the user to be tested according to the relationship value.

8. An electronic apparatus, wherein the electronic apparatus comprises:
at least one processor; and,
a memory communicatively connected to the at least one processor, wherein the memory stores a computer program executable on the at least one processor, and the computer program is executed by the at least one processor to enable the at least one processor to perform:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors; and
constructing a user relationship analysis model based on the feature data, and performing relationship prediction on user data of a preset user to be tested using the user relationship analysis model to obtain user relationships of the user to be tested.

9. The electronic apparatus according to claim 8, wherein the performing training user information division on the original data to obtain target information comprises:
transforming the original data to obtain standard data;
calculating a neighborhood distance of the standard data to obtain a neighborhood mean value;
obtaining a weight coefficient of the standard data, calculating matrix elements of the standard data according to the neighborhood mean value and the weight coefficient using the following formula, and generating a probability transition matrix according to the matrix elements:
$$p = z \frac{{Mean}_{i}}{d ( {x}_{i} , {{x}_{i}}^{k} ) , {p}_{i} > 0}$$
wherein, p represents the probability transition matrix; Meanᵢ represents the neighborhood mean value of an i-th piece of standard data; z represents the weight coefficient of the standard data; d(xᵢ,xᵢ^{k}) represents a distance between the i-th piece of standard data and a neighborhood xᵢ^{k} of the i-th piece of standard data xᵢ;
describing a similarity of the standard data based on the probability transition matrix to obtain a similarity value using the following formula:
$$f = {\sum }_{i = 1} Tp ( z , {x}_{i} )$$
wherein, f represents the similarity value; T represents a preset similarity parameter; p represents the probability transition matrix; z represents the weight coefficient of the standard data; xᵢ indicates as the i-th piece of standard data; and
processing abnormal information of the standard data according to the similarity value to obtain the target information.

10. The electronic apparatus according to claim 9, wherein the transforming the original data into standard data comprises:
converting the original data into a database according to a preset file template to obtain a simulation output file;
generating a database object set according to the simulation output file; and
performing file parsing on the database object set to obtain the standard data.

11. The electronic apparatus according to claim 8, wherein the defining relationships between the training users according to the target information to obtain a user relationship network comprises:
performing relationship judgment on the training users according to the target information, and labeling the training users according to a result of the relationship judgment to obtain an initial user set;
generating an initial user relationship network of the training users according to the initial user set; and
defining relationships of the initial user relationship network to obtain a user relationship network.

12. The electronic apparatus according to claim 8, wherein the performing node feature extraction on the user relationship network according to preset influencing factors to obtain feature data corresponding to the influencing factors comprises:
performing information extraction on the user relationship network according to the influencing factors to obtain a feature set corresponding to the influencing factors;
establishing an influencing factor function according to the feature set;
performing feature extraction on the user relationship network using the influencing factor function to obtain the feature data corresponding to the influencing factors.

13. The electronic apparatus according to claim 8, wherein the constructing a user relationship analysis model based on the feature data comprises:
constructing the user relationship analysis model based on the feature data using the following formula:
$$H = \frac{S - T}{S + T} ;$$
wherein, H represents the user relationship analysis model; S represents the feature data of the training user; T represents a preset relationship parameter of the training user.

14. The electronic apparatus according to claim 8, wherein the performing relationship prediction on user data of a preset user to be tested using the user relationship analysis model to obtain a user relationship of the user to be tested:
performing feature extraction on the user data to obtain feature data of the user to be tested;
performing a relationship calculation on the feature data of the user to be tested using the user relationship analysis model to obtain a relationship value; and
determining the user relationship of the user to be tested according to the relationship value.

15. A non-transient computer-readable storage medium storing a computer program, which, when being executed by a processor, implements:
acquiring original data of training users, and performing training user information division on the original data to obtain target information;
defining relationships between the training users according to the target information to obtain a user relationship network;
performing node feature extraction on the user relationship network according to preset influencing factors to obtain feature data corresponding to the influencing factors; and
constructing a user relationship analysis model based on the feature data, and performing relationship prediction on user data of a preset user to be tested using the user relationship analysis model to obtain user relationships of the user to be tested.

16. The non-transient computer-readable storage medium according to claim 15, wherein the performing training user information division on the original data to obtain target information comprises:
transforming the original data to obtain standard data;
calculating a neighborhood distance of the standard data to obtain a neighborhood mean value;
obtaining a weight coefficient of the standard data, calculating matrix elements of the standard data according to the neighborhood mean value and the weight coefficient using the following formula, and generating a probability transition matrix according to the matrix elements:
$$p = z \frac{{Mean}_{i}}{d ( {x}_{i} , {{x}_{i}}^{k} ) , {p}_{i} > 0}$$
wherein, p represents the probability transition matrix; Meanᵢ represents the neighborhood mean value of an i-th piece of standard data; z represents the weight coefficient of the standard data; d(xᵢ,xᵢ^{k}) represents a distance between the i-th piece of standard data and a neighborhood xᵢ^{k} of the i-th piece of standard data xᵢ;
describing a similarity of the standard data based on the probability transition matrix to obtain a similarity value using the following formula:
$$f = {\sum }_{i = 1} Tp ( z , {x}_{i} )$$
wherein, f represents the similarity value; T represents a preset similarity parameter; p represents the probability transition matrix; z represents the weight coefficient of the standard data; xᵢ indicates as the i-th piece of standard data; and
processing abnormal information of the standard data according to the similarity value to obtain the target information.

17. The non-transient computer-readable storage medium according to claim 16, wherein the transforming the original data into standard data comprises:
converting the original data into a database according to a preset file template to obtain a simulation output file;
generating a database object set according to the simulation output file; and
performing file parsing on the database object set to obtain the standard data.

18. The non-transient computer-readable storage medium according to claim 15, wherein the defining relationships between the training users according to the target information to obtain a user relationship network comprises:
performing relationship judgment on the training users according to the target information, and labeling the training users according to a result of the relationship judgment to obtain an initial user set;
generating an initial user relationship network of the training users according to the initial user set; and
defining relationships of the initial user relationship network to obtain a user relationship network.

19. The non-transient computer-readable storage medium according to claim 15, wherein the performing node feature extraction on the user relationship network according to preset influencing factors to obtain feature data corresponding to the influencing factors comprises:
performing information extraction on the user relationship network according to the influencing factors to obtain a feature set corresponding to the influencing factors;
establishing an influencing factor function according to the feature set;
performing feature extraction on the user relationship network using the influencing factor function to obtain the feature data corresponding to the influencing factors.

20. The non-transient computer-readable storage medium according to claim 15, wherein the constructing a user relationship analysis model based on the feature data comprises:
constructing the user relationship analysis model based on the feature data using the following formula:
$$H = \frac{S - T}{S + T} ;$$
wherein, H represents the user relationship analysis model; S represents the feature data of the training user; T represents a preset relationship parameter of the training user.
